(19) United States
(12) Patent Application Publication
(10) Pub. No.: US 2009/0228149 A1
(43) Pub. Date: Sep. 10, 2009

(54) Environmental control and power system

(75) Inventor: Gerald Allen Alston, Union City, CA (US)

Correspondence Address: FOLEY AND LARDNER LLP;SUITE 500, 3000 K STREET NW, WASHINGTON, DC, 20007, US

(73) Assignee: Glacier Bay, Inc.

(21) Appl. No.: 12/320,372

(22) Filed: Jan. 23, 2009

Related U.S. Application Data
(63) Continuation-in-part of application No. 11/892,021, filed on Aug. 17, 2007.
(60) Provisional application No. 60/822,717, filed on Aug. 17, 2006.

(51) Int. Cl. G05B 15/00; H02P 9/04; H02P 27/00; F25B 27/00

(52) U.S. Cl. 700/276; 290/50; 290/7; 318/400.3; 62/323.3

(57) ABSTRACT

An environmental control and power system (ECAPS) including an ECU with at least one variable-speed compressor driven by a DC motor, wherein the ECU is adapted to condition air and output the conditioned air and a variable-speed diesel engine connected to a generator. The generator is configured to vary in speed so as to output AC power at a variable frequency. The system includes a rectification assembly which transforms the AC power from the generator and/or external AC power into DC power. The ECAPS directs the DC power to the DC motor to drive the variable-speed compressor and varies, in a controlled manner, at least one parameter of the outputted conditioned air from the HVAC system.

### CROSS-REFERENCE TO RELATED PATENT APPLICATIONS

This application is a continuation-in-part of U.S. patent application Ser. No. 11/892,021, filed on Aug. 17, 2007, and also claims priority to and the benefit of U.S. Provisional Application 60/822,717, filed on Aug. 17, 2006, the contents of the foregoing applications are incorporated herein by reference in its entirety.

### BACKGROUND OF THE INVENTION

Military and other emergency response services often need to quickly establish temporary hospital and first-aid shelters to treat injuries on location before patients are transported to more permanent care facilities. These shelters are typically tents or similar poorly insulated habitats that, when located in extremely hot, cold or humid environments, sometimes present an inhospitable environment for the occupants. In many areas, the effective operation of a medical unit is not possible due to extreme environmental conditions.

Typically, in areas where such shelters are provided, there also exists a need to provide electrical power for lights, computers, communication equipment and medical equipment inside the shelter. Indeed, as field medical response becomes more sophisticated, the amount of equipment dependent on reliable electrical power continues to increase.

The military is shifting to rapid-deployment tactics where the ability to quickly move into and out of a danger zone is emphasized. With improved medical techniques relying on the ability to get early treatment to the injured as quickly as possible, it is now necessary to be able to transport and establish medical first responder facilities right alongside the rapidly moving forces. Transporting the required equipment by helicopter and small ground vehicles like Humvees is now commonplace. Indeed, it is not uncommon for “remote surgeries” to be executed, where field doctors perform surgery while working with a surgeon stationed on another continent, communications sometimes constituting visual images communicated between the two locations via satellite(s).

Furthermore, federal, state and local governments and NGOs face a very similar situation as they establish their own highly flexible emergency response teams. These organizations desire to be unburdened by their equipment and logistical support.

### SUMMARY OF THE INVENTION

In a first exemplary embodiment of the present invention, there is an environmental control and power system (ECAPS) unit, comprising an HVAC system with at least one variable-speed compressor driven by a first DC motor, wherein the HVAC system is adapted to condition air and output the conditioned air, a variable-speed diesel engine, a first generator mechanically coupled to the diesel engine and adapted to vary in speed so as to output first AC power at a variable frequency (the first generator being a three-phase permanent magnet generator), a first rectification assembly adapted to transform the first AC power from the generator and/or external AC power to a first DC power, and a first inverter assembly adapted to transform the first DC power to an export AC power. In the first embodiment, the ECAPS unit is adapted to direct the first DC power to the first DC motor to drive the variable speed compressor, the ECAPS unit is adapted to vary, in a controlled manner, at least one parameter of the outputted conditioned air, and the ECAPS unit is a self-contained unit.

In another exemplary embodiment of the present invention, there is an ECAPS unit as described above or below, wherein the first DC motor is a brushless DC motor. In another exemplary embodiment of the present invention, there is an ECAPS unit as described above or below, wherein the first DC motor is a permanent magnet motor. In another exemplary embodiment of the present invention, there is an ECAPS unit as described above or below, the first rectification assembly is configured to also transform the first AC power and/or external AC power to a second DC power, wherein the second DC power is at a substantially lower voltage than a voltage of the first DC power. In another exemplary embodiment of the present invention, there is an ECAPS unit as described above or below, further comprising a second generator mechanically coupled to the diesel engine, wherein the second generator is configured to output power at a substantially lower voltage than a voltage of the first AC power. In another exemplary embodiment of the present invention, there is an ECAPS unit as described above or below, wherein at least one of: (i) the power outputted from the second generator is AC power, and the first rectification assembly is adapted to transform the power outputted from the second generator to DC power, (ii) the power outputted from the second generator is AC power, and the ECAPS unit includes a second rectification assembly, the second rectification assembly being adapted to transform the power outputted from the second generator to DC power, and (iii) the power outputted from the second generator is DC power.

In another exemplary embodiment of the present invention, there is an ECAPS unit as described above or below, wherein the diesel engine is a three-cylinder turbo-charged common rail injection aluminum engine.

In another exemplary embodiment of the present invention, there is an ECAPS unit as described above or below, wherein the first generator is a permanent magnet alternator having a capacity about the same as that of the diesel engine. In another exemplary embodiment of the present invention, there is an ECAPS unit as described above or below, wherein the first generator has eight magnetic poles of neodymium material and is wound on twelve slots.

In another exemplary embodiment of the present invention, there is an ECAPS unit as described above or below, wherein the ECAPS unit includes at least one power buss circuit which directs the first DC power to high voltage loads of the HVAC system including: one or more variable-speed air conditioning compressor motors, one of which is the variable speed compressor DC motor, one or more variable speed condenser fan motors, and one or more variable-speed evaporator fan motors.

In another exemplary embodiment of the present invention, there is an ECAPS unit as described above or below, wherein the one or more variable-speed air conditioning compressors, the one or more variable speed condenser fans, and the one or more variable-speed evaporator fans are powered by permanent magnet brushless DC motors. In another exemplary embodiment of the present invention, there is an ECAPS unit as described above or below, wherein the ECAPS unit is adapted to produce a second DC power, wherein the second DC power is at a substantially lower voltage than a voltage of the first DC power, wherein the ECAPS unit includes at least two power buss circuits which respectively carry the first and second DC powers to internal loads of the ECAPS unit at substantially higher and lower voltage levels. In another exemplary embodiment of the present invention, there is an ECAPS unit as described above or below, wherein all of the internal loads of the ECAPS unit are powered from DC power produced by the ECAPS unit, the DC power produced by the ECAPS unit including the first DC power and the second DC power.

In another exemplary embodiment of the present invention, there is an ECAPS unit as described above or below, wherein the first inverter assembly transforms the first DC power to the export AC power such that the export AC power is a sine wave at least one of 115, 120, 220, 230 and 240 volts and at least one of about 50 hz, 60 hz and 400 hz. In another exemplary embodiment of the present invention, there is an ECAPS unit as described above or below, wherein the HVAC has a capacity of 0-40 kw in heating mode and 5,000-to 60,000 BTU/hr in cooling mode. In another exemplary embodiment of the present invention, there is an ECAPS unit as described above or below, further comprising a liquid-air heat exchanger adapted to dissipate heat from the engine and the first generator so as to decrease the external thermal signature of the ECAPS unit, wherein heated components of the heat exchanger are radiatively shielded from the outside of the ECAPS unit and the ECAPS unit is adapted to direct cooling air discharged from the heat exchanger in a manner to prevent external components of the ECAPS unit from heating above an ambient temperature due to the discharged cooling air.

In another exemplary embodiment of the present invention, there is an ECAPS unit as described above or below, further comprising an exhaust system configured to exhaust combustion gases from the diesel engine in a manner that decreases acoustic noise and decreases the external thermal signature of the ECAPS unit, wherein heated components of the exhaust system are radiatively shielded from the outside of the ECAPS unit and the ECAPS unit is adapted to discharge combustion gases exhausted from the ECAPS unit in a manner to prevent external components of the ECAPS unit from heating above an ambient temperature due to the discharged combustion gases.

In another exemplary embodiment of the present invention, there is an ECAPS unit as described above or below, wherein the HVAC system includes a condenser, wherein the condenser is radiatively shielded from an outside of the ECAPS unit so as to reduce a thermal signature of the ECAPS unit with respect to the condenser. In another exemplary embodiment of the present invention, there is an ECAPS unit as described above or below, wherein the HVAC system is adapted to enter a heat mode through a reverse-cycle with respect to the cooling mode, the ECAPS unit further comprising electrical heating elements adapted to increase a temperature of heated air expelled from the ECAPS unit, the heating elements being powered by the first DC power.

In another exemplary embodiment of the present invention, there is an ECAPS unit as described above or below, further comprising a nuclear-biological-chemical (NBC) warfare sealed conditioned air circuit. In another exemplary embodiment of the present invention, there is an ECAPS unit as described above or below, wherein the first generator is adapted to vary in speed with a variation in speed of the diesel engine so as to output first AC power at a variable frequency. In another exemplary embodiment of the present invention, there is an ECAPS unit as described above or below, further comprising a user interface, wherein the user interface is adapted to permit a user to input control commands to control a temperature of the outputted conditioned air. In another exemplary embodiment of the present invention, there is an ECAPS unit as described above or below, wherein the ECAPS unit is adapted to automatically identify a temperature of air at a location remote from ECAPS unit, and wherein the ECAPS unit includes a processor that includes logic to automatically vary the at least one parameter of the outputted conditioned air in response to the identified temperature of air at remote location so as to automatically effectively maintain a desired temperature of the air at the remote location.

In another exemplary embodiment of the present invention, there is an ECAPS unit as described above or below, wherein the ECAPS unit includes control logic adapted to automatically adjust speeds of one or more compressors and/or one or more blowers based on a difference between a sensed temperature of air and a set temperature set based on a control command inputted by a user indicative of a desired air temperature, wherein the control logic: automatically sets respective compressor and/or blower speeds, upon a determination that the difference is large, to speeds that are higher relative to speeds set upon a determination that the difference is small, automatically sets the respective compressor and/or blower speeds, upon a determination that the difference is small, to speeds that are lower relative to speeds set upon a determination that the difference is large, and the ECAPS unit is adapted to automatically lower the respective compressor and/or blower speeds as the difference decreases.

In another exemplary embodiment of the present invention, there is an ECAPS unit as described above or below, wherein the ECAPS unit includes a load management system which includes a control unit including logic to automatically determine whether one or more loads drawing export AC power and an HVAC system load, individually and/or collectively, present a power demand exceeding a maximum power available from the first generator, wherein the load management system is adapted to automatically shed individual loads so as to reduce the power demand to a level at or below the maximum power available from the first generator, and wherein the load management system is adapted to permit a user to pre-identify an order in which individual loads are to be shed upon shedding of individual loads. In another exemplary embodiment of the present invention, there is an ECAPS unit as described above or below, wherein the first generator is an inductionless generator, and wherein the HVAC system includes: one or more variable-speed air conditioning compressors, one of which is the variable speed compressor, respectively powered by inductionless permanent magnet motors, one or more variable speed condenser fans respectively powered by inductionless permanent magnet motors, and one or more variable-speed evaporator fans respectively powered by inductionless permanent magnet motors. In another exemplary embodiment of the present invention, there is an ECAPS unit as described above or below, wherein the ECAPS unit is adapted to receive external AC power, rectify the external AC power to DC power, and invert the DC power rectified from the external AC power to export AC power, receive external low-voltage DC power, and start the diesel engine with a starter drawing power only from the external low-voltage DC power.

In another exemplary embodiment of the present invention, there is an ECAPS unit as described above or below, wherein the ECAPS unit includes an internal self-diagnostic unit adapted to automatically identify faults with the ECAPS unit and annunciate those faults to a user, the automatically identified faults including insufficient power, low fuel, low lubrication fluid, clogged air filtration, over temperature of the ECAPS unit as a whole and/or one or more sub-components, failure of electronic components, wherein the internal self diagnostic unit is further adapted to identify a deficient safety condition of the ECAPS unit and annunciate such to the user.

### BRIEF DESCRIPTION OF THE DRAWINGS

FIG. 1 presents an isometric view of an exterior of an ECAPS unit according to an embodiment of the present invention.

FIG. 2 presents an isometric view from another side of the ECAPS unit depicted in FIG. 1.

FIG. 3 presents an isometric view of an inside of the ECAPS unit of FIG. 1.

FIG. 4 presents an isometric view from another side of the ECAPS unit depicted in FIG. 3.

FIG. 5 presents an isometric view of a diesel engine utilized in an embodiment of the present invention.

FIG. 6 presents an isometric view of a common rail injection system utilized in the diesel engine of FIG. 5.

FIG. 7 presents components used in a generator according to an embodiment of the present invention.

FIG. 8 presents an isometric view of a DC motor utilized in the present invention.

FIG. 9 presents an architecture of the ECAPS unit according to an embodiment of the present invention.

FIG. 10 presents an isometric view of another embodiment of the ECAPS unit according to the present invention (dimensions in inches).

FIG. 11 presents an interior view of the embodiment of FIG. 10.

FIG. 12 presents a schematic of an embodiment of an ECAPS that includes a plurality of self-contained ECUs connected to a generator unit.

FIG. 13 presents a schematic depicting an ECU in fluid communication with a temporary enclosure.

### DETAILED DESCRIPTION OF THE PREFERRED EMBODIMENTS

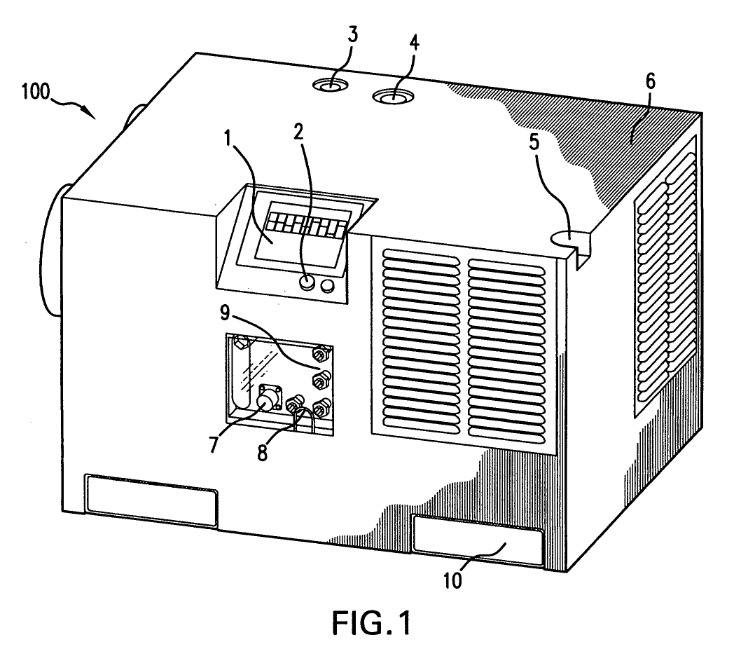

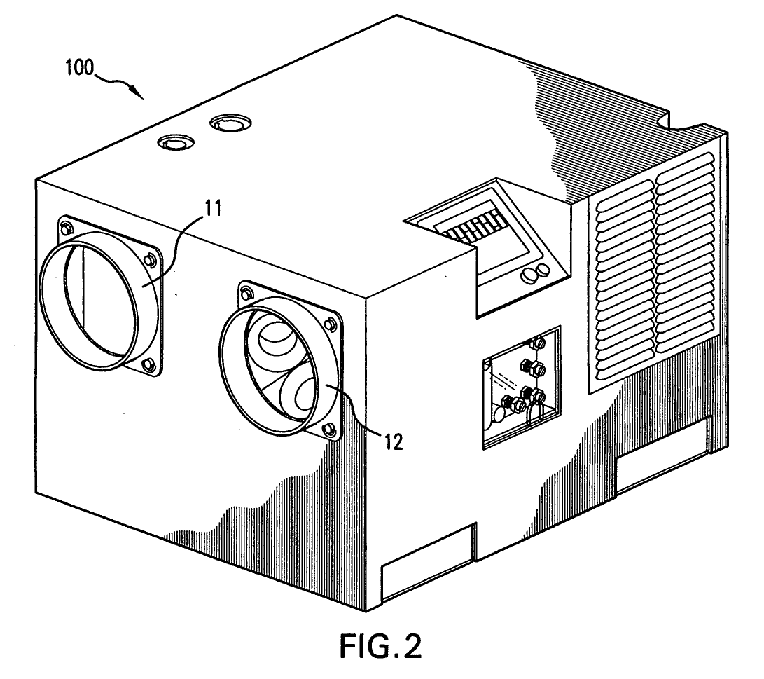

Referring now to FIGS. 1-4, a first embodiment of an Environmental Control And Power System (ECAPS) unit according to an exemplary embodiment of the present invention may be seen. In the embodiments depicted in FIGS. 1-4, the ECAPS unit includes a variable-speed diesel engine 30 and an HVAC system 110 which are supported by a frame 23. In the embodiments presented in FIGS. 1-4, the HVAC system 110 is powered by a generator 27 that is mechanically coupled to the diesel engine 30, the generator 27 producing electrical power which is in turn is used to power the HVAC system 110. According to some of the embodiments depicted in the figures, the HVAC system 110, the generator 27 and the diesel engine 30 are all packaged in a self-contained unit (the ECAPS unit 100).

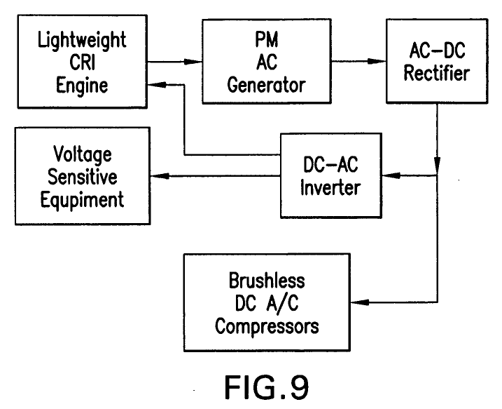

In the embodiments depicted in FIGS. 1-4, the generator 27 is an alternator that outputs AC power at variable frequency. The ECAPS unit includes a rectification assembly 31 which transforms the AC power outputted from the generator 27 into DC power. An inverter assembly 28 transforms DC power that was transformed from the AC power produced by the generator 27 to export AC power, which may be utilized by electrical devices remote from the ECAPS unit. That is, in the embodiment of the present invention depicted in FIGS. 1-4, AC power produced by the generator 27 is rectified to DC power and then inverted back to AC power for export from the ECAPS unit. In the embodiments of FIGS. 1-4, the DC power rectified from the AC power produced by the generator 27 is utilized to power all components onboard the ECAPS unit. FIG. 9 presents a chart detailing a high-level power management architecture according to the embodiment of FIGS. 1-4.

Particular features of the embodiments presented in FIGS. 1-4 will now be described by way of example.

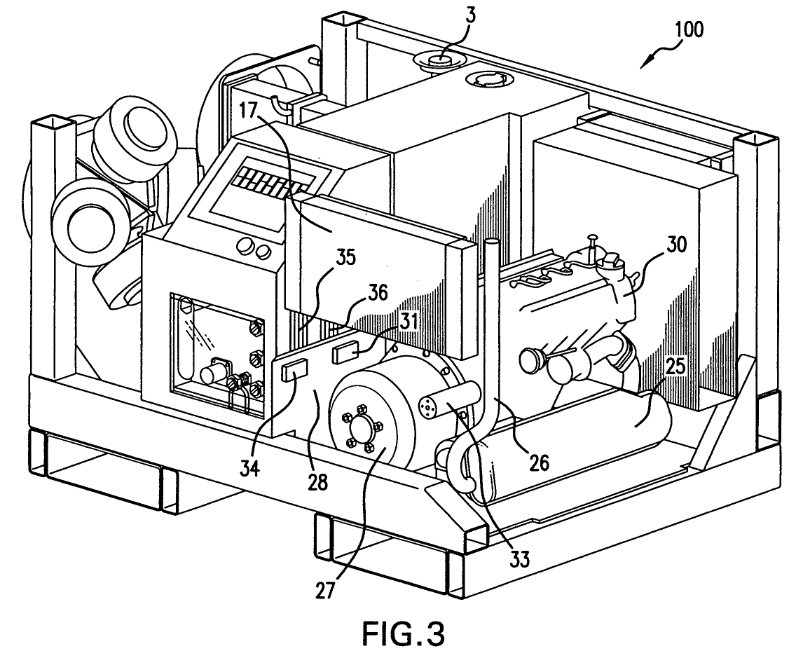

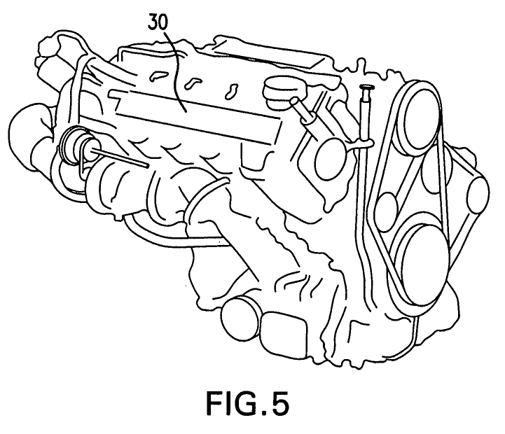

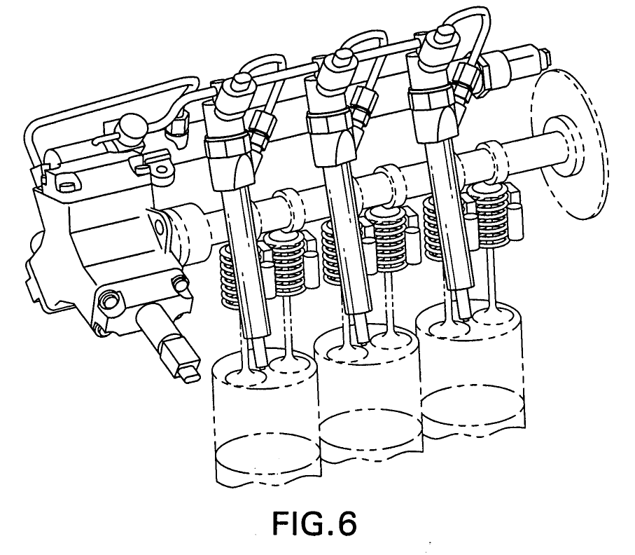

In an exemplary embodiment of the ECAPS unit of FIGS. 1-4, the ECAPS unit includes an efficient light weight common rail injection engine 30, as is exemplary depicted in FIG. 5. In some embodiments, the common rail injection system (as is depicted by way of example in FIG. 6, where the common rail injection system 50 is depicted) provides for efficient use of diesel fuel. The engine 30 depicted in FIG. 5 is a three-cylinder turbo-charged common rail injection diesel aluminum engine, although in other embodiments, different types of diesel engines may be utilized, especially those that are rugged, reliable and efficient (as is the case with many embodiments of the engine 30 depicted in FIG. 3). In some embodiments, the use of turbo charging permits the ECAPS unit to be altitude insensitive/relatively altitude insensitive. Turbo charging may also provide for fuel efficiency and low emissions from the engine 30. The engine 30 depicted in the figures is light weight and relatively very compact. In embodiments utilizing the engine 30 of FIG. 5, there is no wet stacking, and the engine is designed for modular repair. Engine 30 is suitable for 5 kw to 30 kw long term operation, and these parameters may be different for other embodiments. In view of the expectation that the ECAPS unit will be utilized in low temperature environments, some embodiments of the ECAPS unit include a diesel-fired hydronic heater that is configured to pre-heat the diesel engine 30 to improve the temperature operating range of the unit.

As detailed above, the engine 30 is mechanically coupled to the generator 27. Rotational energy of the engine 30 is transferred (e.g., through a coupling to the crankshaft of the engine 30) to the rotational portion of the generator 27. The generator 27 is configured to vary in speed and output AC power at a variable frequency. (In some embodiments, the generator varies in speed in direct proportion to a variation in speed of the engine 30.) In the embodiment depicted in the figures, the generator 27 is a three-phase permanent magnet generator. In the exemplary embodiment depicted in FIGS. 1-4, the generator 27 has a capacity that is about the same as that of the diesel engine 30, although in other embodiments of the present invention, the capacity of the generator 27 may vary with respect to that of the engine 30. In some embodiments, the generator 27 has eight magnetic poles of neodymium material and is wound on twelve slots.

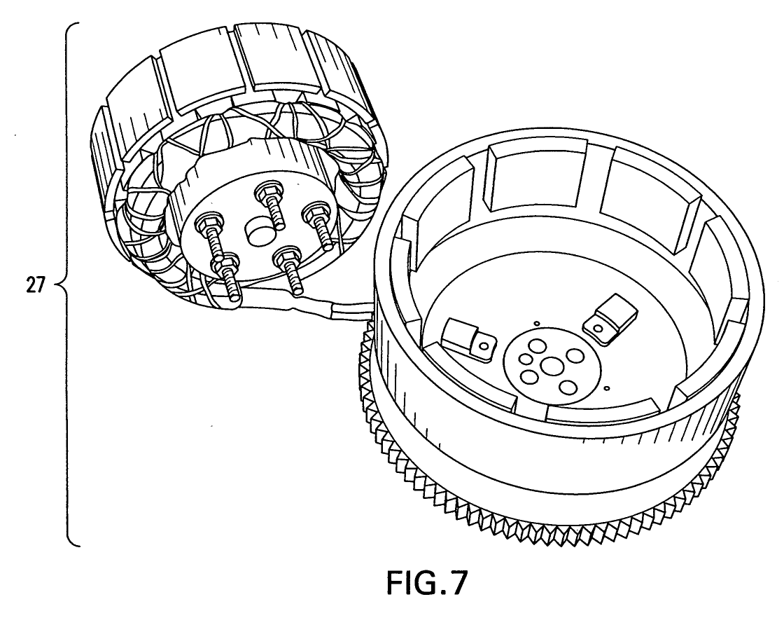

FIG. 7 presents exemplary components of the permanent magnet AC generator 27 utilized in FIGS. 1-4. As noted above, the generator 27 is configured to varying speed with variation and rotational speed of a diesel engine 30. This allows AC power to be outputted from the generator 27 at a variable frequency. That is, a variation in the speed of the engine 30, in some embodiments, will correlate to a variation in the frequency of the AC power outputted by the generator 27. Some embodiments of the generator 27 utilized in the present invention are about 80% or so smaller and lighter than synchronous units. Efficiency of the generator 27 is about 96% which allows for less fuel to be utilized and less heat to be dissipated. A 100% “potted” coil is used in the embodiments depicted of the generator 27. In some embodiments, this permits the generator 27 to be impervious/relatively impervious to the environment.

In some designs of the ECAPS unit of the present invention, the generator 27 may be operated in parallel with other generators, especially in the event that higher capacity is needed.

In some embodiments of the ECAPS unit according to the present invention, as load fluctuates, the voltage produced by the generator 27 may also fluctuate. This may be compensated for, in an exemplary embodiment, by changing the speed of the generator 27. In this regard, the engine/generator assembly may be configured such that the engine 30 slows down as load on the generator 27 is reduced, and visa-versa.

Some embodiments of the present invention further include a second generator 33 (see FIG. 3), in addition to the primary generator 27. (The second generator 33 may be, for example, a small engine-driven alternator, a DC-to-DC converter, or a secondary winding on the main generator, etc.) This second generator 33 is also mechanically coupled to the diesel engine 30 (in the embodiment depicted in FIG. 3, the second generator 33 is coupled via a belt, although mechanical coupling via a torque converter or the like (parts mechanically coupled by fluid), gears, etc., may also be used). In some embodiments, this second generator 33 is configured to output power at a substantially lower voltage than the voltage that is outputted by generator 27. By way of example only and not by way of limitation, if the primary generator 27 outputs voltage at 110 volts, the second generator 33 may produce power at a voltage of, for example, 12 or 24 volts, etc. In some embodiments of the present invention, the power outputted from the second generator 33 is AC power. However, in other embodiments of the present invention, the power outputted from the second generator 33 may be DC power. In embodiments where the power outputted from the generator 27 is AC power, the rectification assembly 31 may be used to rectify AC power from the second generator 33 to DC power. (The rectification assembly 31 may be a passive full bridge rectifier, or in other embodiments, may be an active rectification circuit.) Still, in other embodiments of the present invention, a separate rectifier assembly 34 is used to transform the power outputted from the second generator 33 to DC power. In embodiments of the present invention where the second generator 33 is a DC power generator, the power may not need rectification. Other embodiments of the present invention may include additional generators as well (additional AC generators and/or additional DC generators).

In the embodiment of the present invention of FIGS. 1-4, the rectification assembly 31 is used to transform AC power produced from the generator 27 to DC power. In some embodiments, rectification assembly 31 is configured to transform AC power produced by the generator 27 into two separate DC powers of different voltages (e.g., one high voltage, one low voltage). In some embodiments of the present invention the rectification assembly 31 is used to produce three or more different DC powers, each of which may be at different voltages. As will be discussed in greater detail below, the low voltage DC power is utilized to power, for example, components of the user interface unit 1 (including a user interface screen) that do not require high voltage. Conversely, the high voltage DC power is utilized to power components which require high voltage DC power (e.g., HVAC motors, etc.).

Many embodiments of the present invention are configured to not only generate AC power from the rotational energy produced by the diesel engine 27, but are also designed to receive AC power from an external source. Accordingly, the ECAPS unit can receive power from an external generator and/or an external power pole, which may be desirable in a scenario where the onboard diesel generator may be unavailable and/or the generator cannot be used to produce enough power and/or in a scenario where power from the generator 27 is unwanted. In some embodiments, the rectification assembly 31 is configured to convert this AC power from an external source to DC power, just as it converts (or in an analogous manner to converting) the AC power produced by the generator 27 to DC power. It will be noted that the rectification assembly 31 may include one, two or more rectifiers. The number of rectifiers needed will be determined based on the requirements of a particular ECAPS unit to be built. In this regard, a rectification assembly may include two rectifiers, the first rectifying the power from the generator 27 and the second rectifier rectifying power from the external power source. Indeed, in some embodiments, a rectifier assembly may include three rectifiers with the third rectifier rectifying power from the second generator 33. Of course, separate rectifier assemblies may be utilized for each individual generator. Also, in some embodiments, the same rectifier may be used to rectify the AC power produced by generator 27 and the external AC power. Any device or assembly of devices that will permit the rectification of AC power produced by the onboard generators and will permit the rectification of AC power from external power sources may be utilized to practice the present invention. (Also note that a rectification assembly may include a plurality of rectification assemblies.)

The ECAPS unit includes an external power input connection 9 so that the ECAPS unit can receive power from an external generator and/or an external power pole.

The ECAPS unit depicted in FIGS. 1-4 includes at least two power bus circuits 35, 36, which respectively carry the high voltage and low voltage DC power (from the rectification assembly(s)) to internal loads of the ECAPS unit. By way of example, bus 35 carries a DC voltage at 110/220 volts to the compressor motor 32 of the HVAC system (discussed in greater detail below), and bus 36 carries a voltage of 12 volts to the user interface unit 1 (also discussed in greater detail below).

ECAPS unit 100 includes an inverter assembly 28. Inverter assembly 28 transforms the DC power rectified by one or more of the rectifier assemblies to AC power which may be exported from the ECAPS unit 100 to power, for example, lighting, computers, etc., remote from the ECAPS unit 100. In an exemplary embodiment of the present invention, the inverter 28 is used to transform DC power to AC power in the form of a sine wave at, for example, 115, 120, 220, 230 and 240 volts, which may later be exported from the ECAPS unit as export power. The inverter 28, according to some embodiments of the invention, provides sine wave AC electrical power with minimum voltage ripple. The frequency at which this exported power is at maybe 50 hertz, 60 hertz and/or 400 hertz, etc. The voltages and frequencies in some embodiments may be controlled by a user via imports from the user interface unit 1. Other voltages and/or frequencies may be set by the user than those just specified, in some embodiments. In the embodiment depicted in FIGS. 1-4, voltages and frequencies of power exported from the ECAPS unit 100 are the same as and/or similar to that needed by common components that would be expected to use power from an ECAPS unit or the like.

The ECAPS unit 100 includes connections 8 to permit exterior connection to AC power exported from the ECAPS unit 100 (power from the inverter 28).

Not only can some embodiments of the ECAPS unit 100 according to the present invention receive external AC power and rectify and then invert the power to export AC power, some embodiments of the ECAPS unit 100 are configured to receive external low-voltage DC power as well. (Note the socket receptacle 7 for the low voltage DC power.) In some embodiments of the present invention, this low voltage DC power is utilized to start the diesel engine 30 in a scenario where the battery of the ECAPS unit is dead or otherwise has insufficient charge to crank the diesel engine 30. In some embodiments, this low voltage DC power may be obtained from another separate ECAPS unit 100 according to the present invention. Accordingly, some embodiments of the ECAPS unit 100 according to the present invention include the ability not only to export AC power, but also to export DC power, and thus may have an outlet in the form of a receptacle or the like for exporting this low voltage DC power.

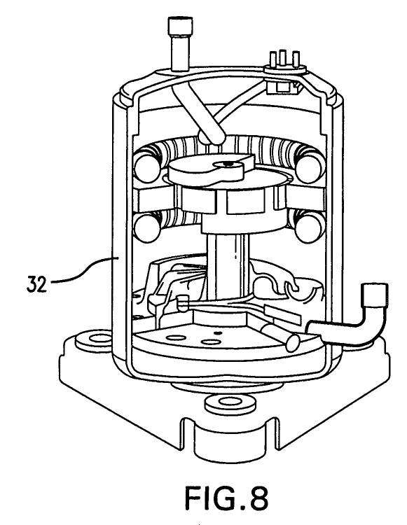

Features of the HVAC system 110 of the ECAPS unit 100 according to the exemplary embodiment depicted in FIGS. 1-4 will now be described. In the embodiment depicted in FIGS. 1-4, the HVAC system 110 includes variable speed components. These components are typically driven by variable speed motors. By way of example only and not by way of limitation, a variable speed compressor 20 is powered by a variable speed DC motor 32, which may be a brushless inductionless DC motor, while in some embodiments, the motor is a permanent magnet brushless DC motor, a synchronous permanent magnet motor, and a switched reluctance motor. In some embodiments, the DC motor includes a rotating component and includes a motor commutation controller, the input power to the motor communication controller being DC power. In some embodiments of the ECAPS unit 100, the compressor speed may vary from 1,000 to 7,000 rpm. Further by way of example, a variable speed condenser fan/blower 15, located adjacent condenser/gas-to-air heat exchanger 13, is also powered by a variable speed DC motor (blower speed may vary from 300 to 4,500 rpm). Still further, the HVAC system 110 according to some embodiments of the present invention may utilize one or more variable speed evaporator fans/blower 19 located adjacent evaporator/liquid-to-air heat exchanger 21, and/or a pump assembly, and/or an electrical resistance heater (discussed in greater detail below). In the exemplary embodiment depicted in the figures, the DC motors powering the HVAC components just mentioned receive DC power through the power bus 35, which directs high voltage power to the high voltage loads of the ECAPS unit 100, such as the motors of the HVAC system, along with, for example, motors for the engine radiator/liquid-to-air heat exchanger blower 16 for the engine radiator 17. In the embodiments depicted in FIGS. 1-4, the motors powering the HVAC unit components are permanent magnet brushless DC motors. An exemplary embodiment of a brushless DC motor 32 used to power the compressor 20 may be seen in FIG. 8. The ECAPS unit 100 according to the embodiment depicted in the figures is configured to direct DC power directly to the motors of the HVAC system. These motors are typically inductionless motors (i.e., in some embodiments, induction motors are not utilized). Inductionless motors used in the embodiment depicted in the figures may be up to 70% smaller and lighter than induction motors. The motors are, in some embodiments, about 97% efficient and variable in speed. Further, the motors used in some embodiments exhibit little or no inductive start up surge when the motors are started. In the exemplary embodiment depicted in the figures, the motors tolerate +/−50% voltage fluctuations, although in other embodiments, more or less robust motors may be utilized. In many embodiments, inductionless permanent magnet motors are utilized.

Operational performance characteristics are the HVAC system 110 according to some of the embodiments of the present invention will now be described.

The HVAC system 110 utilized in the ECAPS unit 100 depicted in FIGS. 1-4 is a reverse cycle HVAC system. The HVAC system 110 may operate in a heating mode and may also operate in a cooling mode. When in the heating mode, the HVAC system 110 may have a capacity of about 0-40 kilowatts. When in the cooling mode, the HVAC system 110 may have a capacity of about 5,000 to 60,000 BTU per hour. The HVAC system is adapted to enter a heat mode through a reverse-cycle with respect to the cooling mode.

The embodiment of the ECAPS unit 100 present in FIGS. 1-4 is designed to permit the ECAPS unit to be placed into fluid communication with a remote structure, such as a tent, a building, a vehicle, a trench that may be relatively enclosed, etc., by attaching tubing/piping, etc., to duct 11, through which the HVAC system discharges conditioned air. (Note that, conditions permitting, a return tube/pipe, etc., in fluid communication with the remote structure, may be connected to duct 12, through which the HVAC system receives return air from the remote structure to which conditioned air is being delivered.) In this manner, the ECAPS unit may be placed a desirable distance from the structure in which climate is desired to be controlled. In this regard, because the ECAPS unit 100 may be used to deliver conditioned air a considerable distance from the ECAPS unit 100, the embodiment of the ECAPS unit 100 of FIGS. 1-4 is configured to identify air temperature at a location remote from ECAPS unit. For example, a wireless (or wire based) sensor may be placed in the remote structure to monitor environmental conditions (e.g., temperature and/or humidity, etc.) and send signals which may be received and analyzed by a control system onboard the ECAPS unit indicative of the monitored condition.

In view of the sophisticated nature of the ECAPS unit according to FIGS. 1-4, some embodiments of the ECAPS unit include a processor with logic (simple circuit, complex circuit, software, firmware, etc.) that permits the ECAPS unit to automatically vary parameter(s) (e.g., temperature, humidity, flow rate, etc.) of the conditioned air being outputted by the unit in response to the monitored condition so as to maintain a desired condition (e.g., temperature) of the air at the remote structure. For example, the control logic of the ECAPS unit may be such that the unit automatically adjusts speeds of one or more of the HVAC compressors and/or one or more of the HVAC blowers based on a difference between a sensed temperature of air and a set temperature set based on a control command inputted by a user into the user interface 1, the control command being indicative of a desired air temperature in the remote structure. In an exemplary embodiment, the control logic may automatically set compressor and/or blower speeds, upon a determination that a difference between desired temperature and current temperature is large, to speeds that are higher relative to speeds set upon a determination that the difference between the desired temperature and the current temperature is small. The control logic may also be configured to automatically set the respective compressor and/or blower speeds, upon a determination that the difference between desired and current temperature is small, to speeds that are lower relative to speeds set upon a determination that the difference between desired and current temperature is large. Further, embodiments of the ECAPS unit include logic to lower the respective compressor and/or blower speeds as the difference decreases, and, alternatively, increase the respective compressor and/or blower speeds as the difference increases, etc. In this regard, the ECAPS unit according to the present invention may include logic based on theoretical and/or empirical analysis of how some parameters (e.g., compressor speed) may be adjusted in view of adjusting other parameters (e.g., blower speed) to achieve a desired environmental condition.

Embodiments of the ECAPS unit 100 may include a power management system as part of the control unit/control system 18. Such a system may include logic to determine whether one or more loads drawing export AC power and/or an HVAC system load, individually and/or collectively, present a power demand exceeding a maximum power available of the ECAPS unit 100. In an exemplary embodiment, the load management system enables the ECAPS unit to shed individual loads so as to reduce the power demand on the ECAPS unit to a level at or below the maximum power available from the unit. Accordingly, the embodiment presented in FIGS. 1-4 permits a user to input into the user interface 1 exactly which individual loads are to be shed in what order in the event that the ECAPS unit enters a “shed-load” regime. For example, a user may input information into the unit such that power to a light or a communication device should be shed instead of shedding power to a medical device, etc.

It is noted that in some embodiments of the present invention, the ECAPS unit is further configured with electrical heating elements 37 that are utilized to increase a temperature of air expelled from the HVAC system. In an exemplary embodiment according to the present invention, these heating elements 37 are powered by DC power from the power bus 35, as the elements are high voltage elements. The electrical heating elements 37 are configured to give the ECAPS unit a boost in heat output in environmental conditions where the reverse cycle of the HVAC system is not sufficient such as may be the case in extremely cold environments.

The ECAPS unit of FIGS. 1-4 includes a user interface 1 (which includes an emergency shut off button 2). The user interface 1 is configured to permit a user to input control commands to control a temperature of the outputted conditioned air, control a humidity of the conditioned air, control a speed of the engine and/or enable/disable export of electrical power, among other things. In some embodiments, the user interface 1 is configured to display current status of various components onboard the ECAPS unit 100, such as, for example, engine temp, engine RPM, oil pressure, power load on the ECAPS, fuel level, estimated run time, maintenance data (e.g., oil change warranted, overhaul warranted, tune-up warranted and/or shut-down warranted), and/or warning information.

As will be readily understood from the background section above, some embodiments of the ECAPS unit according to the present invention will be utilized in battlefield areas/forward deployed locations, where hostilities have and/or are and/or are likely to commence. Accordingly, some embodiments of the present invention are designed to minimize a thermal signature produced by the ECAPS unit during operation of the ECAPS unit. In an exemplary embodiment, the ECAPS unit 100 includes an exhaust system that is configured to exhaust combustion gases from the diesel engine 30 in a manner that decreases the external thermal signature of the ECAPS unit. (Note that the exhaust system may also be configured to decrease acoustical noise produced by the generator. (See engine muffler 25.)) In this exemplary embodiment, components of the ECAPS system that are heated during operation of the ECAPS unit are radiatively shielded from the outside of the ECAPS unit (in some embodiments, these components cannot be seen from the outside). Further, in some embodiments of the present invention, the ECAPS unit is adapted to discharge combustion gases exhausted from the ECAPS unit (such as, for example, through engine exhaust pipe 26 which leads to exhaust port 5) in a manner so as to prevent external components of the ECAPS unit from heating above an ambient temperature due to the discharged combustion gases. In this regard, the figures provide exemplary schematics of one design of an ECAPS unit that accomplishes the just mentioned design features. (Note as well some embodiments permit an extension to be placed onto the exhaust port 5 so as to channel exhaust gases further from the unit 100.) Accordingly, some embodiments of the present invention permit HVAC system operation and/or power generation to be accomplished while leaving a relatively low thermal signature. In some embodiments, the low thermal signature is obtained by limiting the amount of waste heat produced and/or by dissipating heat evenly behind a shield, thereby substantially avoid high point-source discharge. (Also, the efficient operation of the ECAPS unit according to the present invention also affords a reduction in the thermal signature in that it produces less waste heat than would otherwise be produced.) Additionally, because the HVAC and power generator are packaged together, more shielded space is available to dissipate heat before being discharged from the ECAPS unit/to avoid hot spots. Accordingly, some exemplary embodiments of the ECAPS unit operate with a high thermal efficiency and therefore, has less heat to dissipate.

It will be understood that in addition to the diesel engine 30, other components of the ECAPS unit 100 produce/radiate thermal energy. By way of example, and not by way of limitation, the HVAC system condenser 13 will radiate heat. Accordingly, the embodiment depicted in the figures present a configuration where the condenser 13 is likewise radiatively shielded from the outside of the ECAPS unit in a manner that reduces the thermal signature of the ECAPS unit, at least with respect to the condenser 13. The ECAPS unit 100 also includes a engine radiator 17 (liquid-to-air heat exchanger) which is configured to dissipate thermal energy/heat removed from the engine 30. In some embodiments, the radiator 17 is also configured to dissipate thermal energy removed from the generator 27 (note that a separate radiator may also be used to dissipate thermal energy from the generator 27). Exemplary designs of the ECAPS unit 100 are such that cooling air discharged from the radiator 17 is discharged in a manner that prevents external components of the ECAPS unit from heating above the ambient temperature due to the discharged cooling air. In keeping with the design feature that the ECAPS unit leaves a reduced/minimized thermal footprint, the heated components of the heat exchanger/radiator 17 are radiatively shielded from the outside of the ECAPS unit (in some embodiments, these components cannot be seen from the outside).

It will be noted that in some embodiments of the present invention, the fuel tank 14 with fuel fill port 4 (shown capped) is integral to the ECAPS unit and is nestled between the engine 30 and the HVAC with a fuel lubricity additive fill port 3 (shown capped) leading to fuel lubricity additive reservoir 24 so that lubricating fluid may be added to the fuel if necessary. In alternate embodiments, the ECAPS unit includes a storage reservoir and metering pump that automatically injects a measured amount of lubricating agent into the fuel tank (to improve the lubricity of the fuel when using low-lubricity fuels). Other embodiments may also include an oil fill port with cap (not shown) for adding lubrication fluid to the engine 30 in more traditional manner. Various embodiments of the ECAPS unit 100 are such that the fuel tank 14 is of sufficient volume to provide continuous operation at the expected loads for a sufficient duration. The fuel tank 14 has, in some embodiments, a fuel filler port 14 (shown capped) located on the top in a manner that fuel may be added to the tank from the outside. In regard to fueling, some embodiments of the ECAPS unit are designed such that the diesel engine 30 can run on a variety of types of fuel. In this regard, a use scenario may include utilizing low-lubricity fuels such as, for example, JP-8, etc.

Embodiments of the invention include a sound reducing and environmentally protective enclosure 6 to which forklift runners 10 are affixed. In some embodiments these runners 10 are permanently located to the enclosure cover/ECAPS unit or another embodiment they may be removable. The forklift runners 10 aide in transport of the ECAPS unit by forklift.

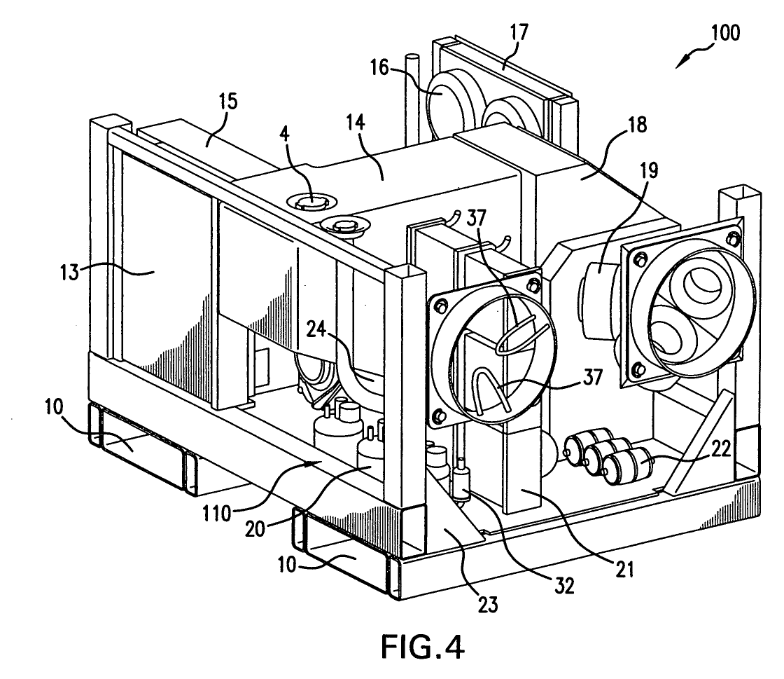

In the embodiment depicted in FIG. 4, an HVAC filter/dryer 22 is present. In an alternate embodiment of the ECAPS unit, the HVAC system includes a humidity control section that allows a humidity level to be maintained. The user interface 1 may permit a user to enter a desired humidity level and/or to simply indicate a desire to adjust humidity in a certain direction. The humidity control section would include a humidity sensor coupled to closed loop or open loop control system to control the humidity level. In view of the possibility that some ECAPS units may be used during armed conflicts, some embodiments of the ECAPS unit 100 include a nuclear-biological-chemical (NBC) warfare sealed conditioned air circuit, although some embodiments may simply seal the conditioned air circuit against biological and/or chemical warfare agents. Accordingly, in some embodiments of the present invention, NBC filters may be utilized, and the ECAPS unit is thus configured to receive such filters. As would be understood by one skilled in the art, some embodiments of the present invention configured for use in an NBC environment are hardened against NBC warfare agents.

Again, in many embodiments of the ECAPS unit 100 according to the present invention the AC power from the inverter 28 is used only for export power. That is, it is not used to power onboard systems of the ECAPS unit 100. (In many embodiments, all electrical devices on the ECAPS unit are powered from the internal high voltage and/or internal low voltage DC buses.)

Some embodiments of the present invention provide utility in that it provides a clean and stable 50 hz or 60 hz AC power in one or more voltages. Further, some embodiments of the present invention are fuel efficient, which is often useful in emergency situations where fuel may be in short supply. Some embodiments of the present invention obtain fuel efficiency by adjusting the speed of the diesel engine/generator to match or otherwise correlate to the load placed on the generator. That is, the diesel engine/generator used in at least some embodiments of the present invention do not continue to operate at full speed when different loads are placed on the generator. By way of example only and not by way of limitation, the diesel engine may operate at 1800 RPM when heavy loads are applied to the ECAPS unit, but then operate at 1000 RPM when medium loads are applied to the ECAPS unit. Of course, other embodiments may operate at a higher and/or lower RPM than 1800 at such high loads, and/or operate at a higher and/or lower RPM than 1000 at medium loads, etc. These embodiments may be practiced as long as they permit the ECAPS unit to be relatively closely and/or efficiently matched to the operating conditions exposed to the unit. In this regard, in some embodiments of the present invention, by operating the generator and the HVAC compressors, blowers, etc., at variable-speeds, the capacity of each can be closely matched to the load and thereby optimized for maximum efficiency, thus improving fuel efficiency.

Some embodiments of the present invention permit the ECAPS unit to be more easily transported by air, land, and/or water during an emergency. In this regard, some embodiments of the present invention are relatively small, and are made relatively small, for example, through the use of non-induction motors, non-induction generators. In some embodiments, permanent magnet generators, motors, etc., are utilized, which produce much greater power with less weight and size. (Some embodiments utilize all permanent magnet components, while others use a combination of components.) Also, the relative efficiency of the engine, generator(s), motor(s), etc., affords fuel efficiency which permits a reduction in weight and/or size of the ECAPS unit, in that less fuel must be carried (more fuel adding to the total weight and size of the unit). Also, weight reduction, size reduction, and/or ease of transportability are relatively achieved by packaging the HVAC system and the export power generation system together in one unit. (Logistics are also relatively simplified.)

Some embodiments of the present invention eliminate or otherwise sufficiently mitigate the occurrence of voltage sag conditions (“brown out”). It has been determined that sometimes excessively long or undersize cables are used to get the power to locations where the power is required. As a result, a significant voltage drop can be induced when the load is applied. This is significant because compressors, computers, and other sensitive equipment such as X-ray machines, etc., can fail/overheat when powered under the design voltage. Accordingly, embodiments of the present invention address this phenomenon by permitting an external power source to be first connected to the ECAPS unit, which rectifies all of the external power to DC power. The power which is exported from the ECAPS unit (for use by external appliances) is inverted from the rectified DC power and, in the process, corrected back to the proper AC voltage level. In scenarios where the external power is being used to operate the HVAC system of the ECAPS unit (i.e., instead of powering the HVAC system from the generator driven by the engine), operating all of the components from the rectified external power (the DC power) affords, in some instances, immunity from voltage drops in the external power.

Some embodiments of the present invention are designed to meet or exceed some or all of the operating characteristics of current FDECU & 30 kw TQGs. Some embodiments of the present invention provide 15 kw “clean” exportable 120/240 vac power, 65,000 BTU/hr of air conditioning and heat, while avoiding/eliminating “brownouts” of sensitive equipment, without “wet stacking” of generators at low loads. Some embodiments are designed to have relatively low emissions while permitting relatively swift field repair. It is noted that an exemplary embodiment of the ECAPS unit 100 according to the present invention has a weight of about 1590 pounds with a cube volume of 53 cubic feet. Some embodiments of the present invention utilize a composite frame and enclosure of low weight and high durability, and utilizes state-of-the-art self-diagnostics with pre-failure notification. In this regard, an exemplary internal self-diagnostic unit utilized with the ECAPS unit 100 may be configured to identify faults with the ECAPS unit and annunciate those faults to a user. Identified faults may be, by way of example only and not by way of limitation, include insufficient power, low fuel, low lubrication fluid, clogged air filtration, over temperature of the ECAPS unit as a whole and/or one or more sub-components, failure of electronic components. The internal self diagnostic unit may identify a deficient safety condition of the ECAPS unit and annunciate such to the user.

Some embodiments permit expansion of capacity up to 200 kw, while others even more.

An exemplary scenario of use of an ECAPS unit according to an exemplary embodiment of the present invention will now be described. Accordingly, any embodiment of the ECAPS unit which may be designed and fabricated to permit the following exemplary scenario to be executed is considered within the scope of the present invention. (Indeed, it is noted that the present invention includes any self-contained unit with devices adapted to permit any or all of the features/capabilities described herein to be performed/executed.)

In a typical example of use, the ECAPS unit is first removed from a transport vehicle by forklift or other lifting machine and set down within about 5 meters of an emergency treatment shelter, such as, for example, a tent. Two flexible air ducts would be installed to connect the inlet and outlet 11 and 12 of the ECAPS unit to air ports on the tent. These ducts provide a conduit for circulating air from the tent, through the HVAC system 110 of the ECAPS unit 100 for heating or cooling (as desired) and back into the tent. The ducts utilized in this scenario are insulated and about 12″ to 20″ in diameter, although in other scenarios of use, non-insulated ducts are used (indeed, corrugated piping might be used in an exemplary scenario).

Depending on the risk involved (proximity of the tent to the ECAPS unit, wind direction, etc.), an extension may or may not be added to the exhaust outlet of the diesel engine to reduce the risk of CO entering the tent.

Next diesel fuel is added to the integral fuel tank. If a low lubricity fuel such as JP 8 is used, an optional metering pump automatically pumps the correct amount of lubricating additive from an on-board reservoir into the fuel.

The operator next programs the desired temperature into the user interface 1 and starts the system. If the optional remote sensor is being utilized, it is placed in a location of critical temperature control within the tent—wirelessly transmitting the sensed temperature back to the control unit 18 on the ECAPS system. If the remote sensor is not being used, the temperature of the air will be read as the air passes through the ECAPS unit and that temperature is used to control the ECAPS unit.

The running engine now turns the permanent magnet generator 27 which in turn produces an AC voltage at a frequency dependent on the speed of rotation. This AC power passes through a passive full bridge rectifier, or in other embodiments, an active rectification circuit, and is converted to DC power. This DC power is fed to the main (higher voltage) power buss. A second device (for example, a small engine-driven alternator, a DC-to-DC converter, or a secondary winding on the main generator, etc.) produces a smaller amount of DC power at a lower voltage level.

The primary (higher voltage) buss, now energized, begins to provide the main power to the fans, blowers, compressors, resistance heaters, etc., as well as the export power inverter. The secondary (lower voltage) buss begins charging the engine starting battery and provides a lower voltage to the control circuits.

With the generator running and the desired temperature set, the ECAPS unit automatically adjusts the speed of the compressors and blowers based on the delta between the actual measured temperature and the desired set point. A higher delta results in a higher compressor and blower speed thereby providing higher capacity to rapidly move the temperature toward the set point. As the temperature nears the set point, the compressor and blowers slow to reduce the system capacity. Ultimately, the control system onboard the ECAPS unit adjusts the HVAC capacity to match that required to maintain the set point temperature. It is noted, however, some embodiments of the ECAPS unit permit a user to override the control logic in the event that the control logic is malfunctioning (as may be the case after a detonation producing an electromagnetic pulse). A user may override the system with a simple switch, or, alternatively, may rig bypasses around the control system and/or otherwise make adjustments to components himself or herself.

As the HVAC system changes capacity to match the required set point, the electrical load on the generator changes. To optimize fuel efficiency, the generator adjusts speed to provide the required power efficiently.

The ECAPS begins to provide clean, exportable AC power for non-internal devices via the DC-to-AC inverter. In this exemplary scenario, powered devices such as lights, computers, communications equipment, decontamination equipment and electrically powered medical devices, etc., are connected to the ECAPS unit. These devices are plugged into a socket provided on the front of the ECAPS unit. The power exported from the unit is drawn from the primary DC buss. The additional load on the generator is taken into account by the controls system when optimizing the engine speed for fuel efficiency.

In the event that the total of the exportable AC power and the HVAC system load exceed the power available from the generator, load will be shed according to the preferences entered by the operator via the user interface and/or a pre-programmed regime.

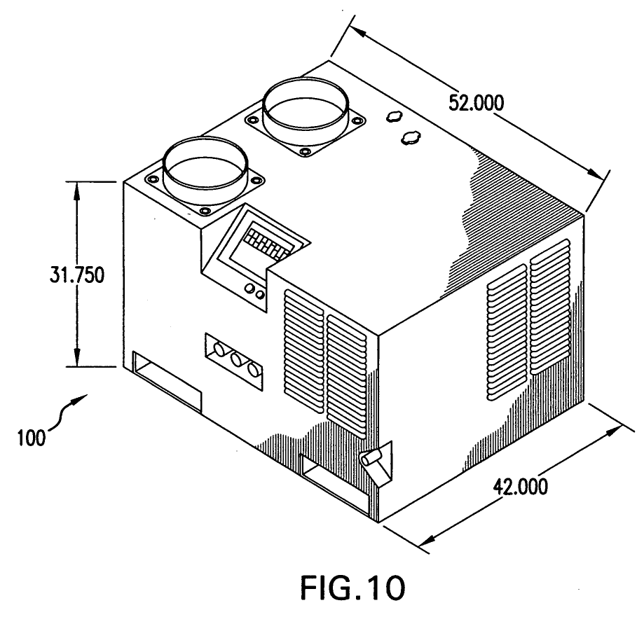

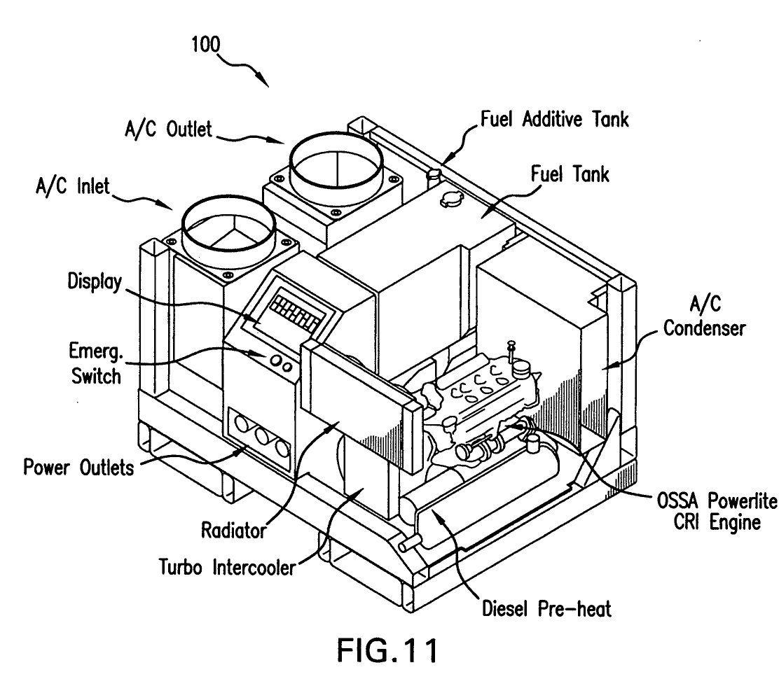

FIGS. 10 and 11 present an alternate layout of an alternate embodiment of the ECAPS unit 100 according to the present invention.

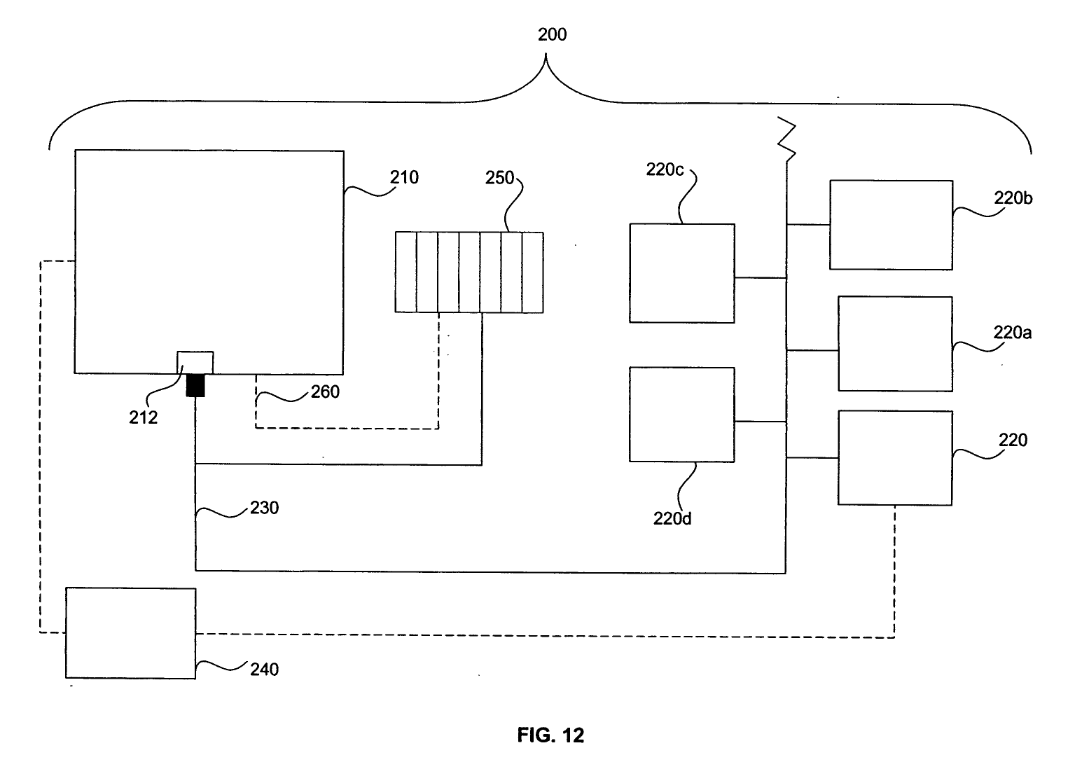

As can be inferred from the above, embodiments of the present invention may include systems where the generator unit and the HVAC unit are separate. By way of example and not by way of limitation, some embodiments may include a self-contained power generator unit that is coupled to a self-contained environmental control unit (ECU) by a power connector. In this regard, referring to FIG. 12, an embodiment of the present invention includes an environmental control and power system (ECAPS) 200. The ECAPS 200 includes a self-contained variable-speed generator unit 210. This unit 210 may have many of the features of the self-contained ECAPS unit 100 described above, such as, for example, a variable-speed internal combustion engine (compression ignition engine/diesel engine) 30, a primary generator 27 mechanically coupled to the engine and adapted to vary in speed so as to produce AC power at a variable frequency, and rectification assembly 31 (which may be/include a passive rectifier and/or an active rectifier), which is used to transform the first AC power produced by the generator 27 and/or external AC power to produce DC power. In some embodiments, the unit 210 includes an inverter assembly 28 and/or may be used with a portable inverter assembly 250, as shown in FIG. 12 (more on this below). In some embodiments, the unit 210 may include the second generator 33, the power bus circuits, etc. In some embodiments, the unit 210 may include any component included in the self-contained ECAPS unit 100 as discussed above, individually and/or in combination, especially those components that are utilized to produce and manage electrical power, and/or have some or all of the capabilities of the ECAPS unit 100, as described above. In the embodiment depicted in FIG. 12, the generator unit 210 outputs DC power produced by the rectification assembly as output DC power through power outlet 212.

The ECAPS 200 also includes a self-contained environmental control unit (ECU) 220 which receives DC power external from the ECU 220 via power cable 230. The ECU 220 includes a variable-speed compressor driven by a variable speed DC motor powered by the received DC power external from the ECU 220. In an exemplary embodiment of the ECU 220, the ECU 220 is an HVAC system, which, in some embodiments, is an electrically powered Rankin-cycle refrigeration circuit in which more than 50% of the electrical power consumed by the refrigeration circuit is DC power. In some embodiments, the ECU 220 may include any single component included in the ECAPS unit 100, individually and/or in combination, especially those components that are utilized to condition air/cool air and/or have some or all of the capabilities of the ECAPS unit 100, as described above. For example, the ECU 220 may include the HVAC system 110, compressor 20, fan/blower 15, heat exchanger 13, fan/blower 19, heating elements 37 and/or heat exchanger 21, etc.

As discussed above, the ECAPS 200 also includes a power cable 230, which transfers at least a portion of the output DC power from the variable speed generator unit 210 to the ECU 220. Using the power cable 230, at least a portion of the output DC power transferred from the variable speed generator unit 210 to the first ECU 220 is the received DC power received by the ECU 220.

The ECAPS of FIG. 12 includes a self-contained inverter assembly 250 which is separate from the variable speed generator unit 210. This inverter assembly 250 receives DC power external from the inverter assembly through power cable 230 (or, in an alternative embodiment, through a separate power cable 260), and inverts the received DC power received by the separate inverter assembly 250 into output AC power. This output AC power is then outputted from the separate inverter assembly 250, for use in standard AC powered components (e.g., lights, portable fans, televisions).

In some embodiments of the ECAPS, there are a plurality of self-contained ECUs connected to the generator unit 210. As may be seen in FIG. 12, an ECU 220a, 220b, 220c and 220d may be connected to the generator unit 210, in addition to ECU 220, via cable 230 (and/or using separate cables), these additional ECUs having similar and/or the same features of the ECU 220 described above, although in other embodiments, the ECUs may be different, as long as they may be operated by external DC power. (Additional ECUs may also be included, which are not shown.) Indeed, in some embodiments, one or more of the additional ECUs may be an ECAPS unit 100 where the HVAC system 110 is powered in part or in full by the generator unit 210 (as opposed to the on-board generator of that particular ECAPS unit 100).

The ECAPS of some embodiments of the present invention may include a controller 240 which is in communication with one or more of the ECUs (it may be separate from the ECU(s) and/or integral with one or more of the ECUs (i.e., part of the ECU(s))), and controls the ECUs to vary the speed of the variable-speed compressor depending on a need for cooled air and/or heated air) outputted by the ECU(s). The controller 240 may also be in communication with the generator unit 210 (it may be separate from the generator unit 210 and/or integral with the generator unit 210 (i.e., part of the generator unit 210)), and adapted to control a speed of the engine and the generator in the generator unit 210. In some embodiments, the controller 240 controls the DC power produced by the generator unit 210 to have a desired first voltage value and a first current value. The controller 240 may be configured to vary the speed of the variable-speed compressor to meet the need for conditioned air (e.g., cooled air) in a shelter (e.g., a temporary shelter such as a tent or other soft-walled structure), in an energy efficient manner (e.g., the most energy efficient manner). The controller 240 may control the speed of the engine and generator of the generator unit 210 to provide the DC power having a desired voltage value and a desired current value from the rectification assembly of the generator unit 210 with a minimum of fuel consumption by the engine.

In some embodiments, there is one controller 240 for each ECU, while in other embodiments, a single controller may be used in an ECAPS that includes a plurality of ECUs.

Certain performance characteristics of the ECAPS will now be described. In a first embodiment of the ECAPS depicted in FIG. 12, the DC power outputted from generator unit 210 through outlet 212 is approximately 100 percent of any power produced by the generator unit 210 not consumed by the generator unit 210 for on-board purposes. (In an exemplary embodiment, the rectification assembly of the generator unit 210 (and the ECAPS unit 100) may transform 100% of the AC power produced by the generator into DC power having a first voltage value and a first current value.) By way of example only and not by way of limitation, the generator unit 210 may include an on-board battery used to power an electric starter and/or used for limited power purposes (e.g., to power control components, display components, etc.), and the DC power generated by the generator in the generator unit 210 may be used to charge the battery and/or power control components, display components, etc., thus using the DC power for on-board purposes. Accordingly, the power used to charge the battery and/or power the control/display components is not included in the approximately 100 percent just discussed. In the same vein, the power received by the ECU 220 used by the ECU to operate the variable-speed compressor, and not consumed by the ECU for onboard control purposes and/or ancillary power requirements (e.g., to charge a battery), is approximately 100 percent DC power. By way of example, in the case where the ECU includes a controller (e.g., controller 240), the controller may be powered by DC power received by the ECU, while approximately 100 percent of the remaining received DC power is used to operate the variable-speed compressor.

As with the ECAPS unit 100, the ECAPS of FIG. 12 may include a power management system as part of the control unit 240. In some embodiments, the power management system is the same as that described above for the ECAPS unit 100.

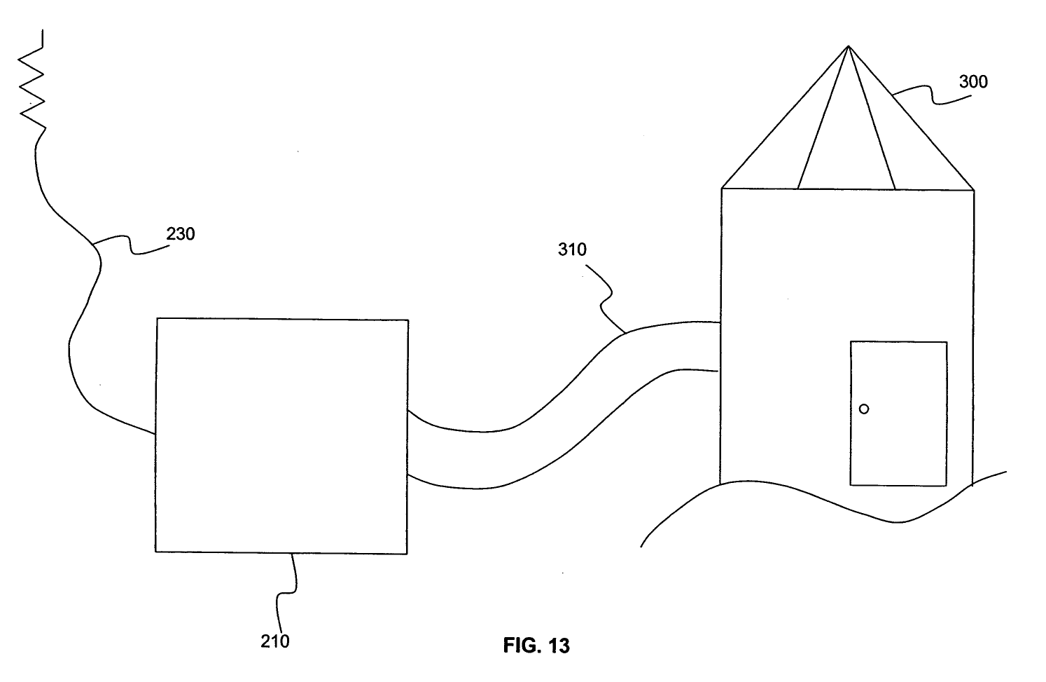

Referring to FIG. 13, in some embodiments, of the present invention, the ECU 200 is in fluid communication with a temporary enclosure, such as a soft-walled enclosure tent 300. The ECU delivers conditioned air to the tent 300 through ducting 310, which, in some embodiments, comprises a plurality of ducts to permit return air to be recirculated through the ECU. In embodiments utilizing a plurality of ECUs (e.g., 220a, 220b, etc.), each ECU could provide conditioned air to a plurality of tents 300. In some embodiments, an individual ECU may provide conditioned air to a plurality of tents as well. In some embodiments, an individual ECU is configured to uniquely control the environment in each tent, while in other embodiments, the climate control is uniform between the tents.

In some embodiments of the present invention, the ECAPS is configured to substantially maintain the voltage of the output power from the generator of the generator unit. In an exemplary embodiment, upon the increase of an electrical load on the generator, the variable speed engine will speed up (i.e. increase RPM) to maintain the proper voltage of power outputted from the generator. That is, as the current increases, the generator speeds up to counteract what would otherwise be a resulting voltage drop, and thus maintain the voltage at the desired level. Conversely, in some embodiments, upon a decrease in load on the generator, the variable speed engine will slow down (i.e. reduce rpm) so as to avoid a voltage spike as current drops. That is, the engine will slow down, and thus the generator RPM will drop, to counteract the effects of the drop in current on voltage.

In some embodiments, the voltage of the electricity outputted by the generator will vary, while in other embodiments, the voltage may be constant, and thus it will not vary.

In some embodiments of the present invention, the ECAPS will include a sophisticated system which will provide an indication that a load on the generator is increasing. By way of example only and not by way of limitation, in an exemplary embodiment, the ECU may be configured to oscillate, or otherwise stagger a change in speed of the variable speed compressor, and thus the variable speed DC motor powering the variable speed compressor, in a manner such that the current outputted by the generator will vary in a predetermined manner such that the controller may “decode” this pattern and forecast the future load that will be placed on the generator. By way of example and not by way of limitation, just prior to a dramatic increase in compressor speed, the variable speed compressor/motor may increase in speed ten percent, and then decrease back to its prior speed, then increase again by ten percent and then decrease to its prior speed over a predetermined period of time, and a controller monitoring the current output of the generator will identify a current fluctuation having a pattern corresponding to that indicating a certain speed variation of the compressor/motor, and thus be able to forecast the increased load. Various patterns may be utilized to forecast various different loads. In such a manner, the power connection assembly may be used as a communication device between the ECU and the generator unit without the need of additional communication systems (a wire-based system or a wireless system, etc.). Of course, in other embodiments of the present invention, a separately wired system or a wireless system may be utilized to enable the generator to forecast loads applied on the generator. As previously noted in other embodiments of the present invention, the controller may be such that it is configured to recognize the increased load as it occurs in real time, and compensate for it in real time. That is, the controller of the ECAPS may be responsive enough to adjust the speed of the engine/generator so as to have a minimal lag time with respect to the change in load. In some embodiments, a combination of these features may be utilized as well. In this regard, any feature that will permit the generator to vary in speed via a variation in speed of the engine so as to compensate for a changed load on the generator as a result of a changed compressor speed/DC motor speed that drives the compressor, may be utilized to practice embodiments of the present invention.

Given the disclosure of the present invention, one versed in the art would appreciate that there are other embodiments and modifications within the scope and spirit of the present invention. Accordingly, all modifications attainable by one versed in the art from the present disclosure within the scope and spirit of the present invention are to be included as further embodiments of the present invention.

What is claimed is:

1. A system adapted to control an air temperature in a temporary enclosure, comprising:
a variable-speed generator unit, including:
a variable-speed compression ignition engine;
a first generator mechanically coupled to the engine and adapted to vary in speed so as to produce first AC power at a variable frequency;
a first rectification assembly adapted to transform 100% of the first AC power produced by the first generator to a first DC power having a first voltage value and a first current value; and
an inverter adapted to invert at least a portion of the first DC power to a fixed-frequency AC power, the fixed-frequency AC power being a power suitable for standard AC powered components;
a first HVAC unit receiving at least a portion of the first DC power, the first HVAC unit including a variable-speed compressor and being driven by a first DC variable-speed motor powered by the first DC power, the first HVAC unit including a Rankin-cycle refrigeration circuit powered by electricity, the electricity powering the refrigeration circuit being more than 50% DC electrical power; and
a controller in communication with the first HVAC unit and adapted to vary the speed of the variable-speed compressor depending on a need for cooled air in the temporary enclosure, the controller also being in communication with the generator unit and adapted to control a speed of the engine and first generator to provide the first DC power having the first voltage value and the first current value from the first rectification assembly.

2. The system of claim 1, wherein the temporary enclosure is a soft-walled enclosure.

3. The system of claim 1, wherein the first generator is a permanent magnet alternator, and wherein the first rectification assembly includes at least one of a passive rectifier and an active rectifier.

4. The system of claim 1, wherein the first DC variable-speed motor is selected from the group consisting of a permanent magnet brushless DC motor, a synchronous permanent magnet motor, and a switched reluctance motor.

5. The system of claim 1, wherein the first DC variable-speed motor is a device with a rotating component and includes a motor commutation controller, the input power to the motor communication controller being DC power.

6. The system of claim 1, wherein the controller is adapted vary the speed of the variable-speed compressor depending on a need for cooled air in the temporary enclosure in the most energy efficient manner, and wherein the controller controls the speed of the engine and first generator to provide the first DC power having the first voltage value and the first current value from the first rectification assembly with a minimum of fuel consumption.

7. The system of claim 1, wherein the compressor is connected to a common shaft and receives power from the first DC variable-speed motor, wherein the first DC variable-speed motor is a brushless DC motor, wherein the first HVAC unit includes a DC powered fan assembly, a DC powered pump assembly, and a DC powered electrical resistance heater, the DC powered fan assembly, the DC powered pump assembly, and the DC powered electrical resistance heater being powered by the first DC power.

8. An environmental control and power system (ECAPS), comprising:
a variable-speed generator unit, including:
a variable-speed internal combustion engine;
a first generator mechanically coupled to the engine and adapted to vary in speed so as to produce first AC power at a variable frequency; and
a first rectification assembly adapted to transform the first AC power produced by the first generator and/or external AC power to produce a first DC power,
wherein the generator unit is adapted to output the first DC power produced by the first rectification assembly as first output DC power;
a first environmental control unit (ECU) adapted to receive DC power external from the first ECU, the first ECU including a first variable-speed compressor driven by a first DC motor including a rotor, a stator and a commutation controller, powered by the received DC power external from the first ECU, the first variable-speed compressor being part of a refrigeration circuit of the ECU, the ECU being adapted to cool air and export the cooled air out of the ECU; and
a power connection assembly adapted to transfer at least a portion of the first output DC power from the variable-speed generator unit to the first ECU,
wherein the at least a portion of the first output DC power transferred from the variable-speed generator unit to the first ECU is the received DC power received by the first ECU.

9. The ECAPS of claim 8, further including an inverter assembly separate from the variable-speed generator unit, the separate inverter assembly adapted to receive DC power external from the inverter assembly, invert the received DC power received by the separate inverter assembly into output AC power, and output the output AC power from the separate inverter assembly, wherein the power connection assembly is adapted to transfer at least a portion of the first output DC power from the variable-speed generator unit to the separate inverter assembly, and wherein the at least a portion of the first output DC power transferred from the variable-speed generator unit to the separate inverter assembly is the received DC power received by the separate inverter assembly.

10. The ECAPS of claim 9, wherein the generator unit is a self-contained unit, wherein the first ECU is a self-contained unit, and wherein the inverter assembly is a self-contained unit, and wherein the power connection connects the generator unit to the ECU and the inverter assembly.

11. The ECAPS of claim 8, further comprising:
a second ECU adapted to receive DC power external from the second ECU, the second ECU including a second variable-speed compressor driven by a second DC motor powered by the received DC power external from the second ECU,
wherein the generator unit is a self-contained unit, wherein the first ECU is a self-contained unit, and wherein the second ECU is a self-contained unit,
wherein the power connection assembly is adapted to transfer at least a portion of the first output DC power from the variable-speed generator unit to the second ECU, and
wherein the at least a portion of the first output DC power transferred from the variable-speed generator unit to the second ECU is the received DC power received by the second ECU.

12. The ECAPS of claim 11, further including an inverter assembly separate from the variable-speed generator unit, the separate inverter assembly adapted to receive DC power external from the inverter assembly, invert the received DC power received by the separate inverter assembly into output AC power, and output the output AC power from the separate inverter assembly, wherein the power connection assembly is adapted to transfer at least a portion of the first output DC power from the variable-speed generator unit to the separate inverter assembly, wherein the at least a portion of the first output DC power transferred from the variable-speed generator unit to the separate inverter assembly is the received DC power received by the separate inverter assembly, and wherein the inverter assembly comprises a stack of a plurality of inverters that individually output AC power.

13. The ECAPS of claim 8, further comprising a controller in communication with the first ECU and adapted to vary the speed of the first variable-speed compressor depending on a need for cooled air outputted by the ECU, the controller also being in communication with the generator unit and adapted to control a speed of the engine and first generator and to control the first DC power to have a first voltage value and a first current value.

14. The ECAPS of claim 8, further including an inverter assembly integral to the variable-speed generator unit, the integral inverter assembly adapted to receive the first DC power and adapted to invert the received first DC power received by the integral inverter assembly into output AC power, wherein the variable-speed generator unit is adapted to output the output AC power produced by the integral inverter assembly through an export AC power outlet integral to the variable-speed generator unit.

15. The ECAPS of claim 8, wherein the first generator is a permanent magnet alternator.

16. The ECAPS of claim 8, wherein the first output DC power is approximately 100 percent of any power produced by the generator unit not consumed by the generator unit for on-board purposes.

17. The ECAPS unit of claim 16, wherein the generator unit includes an on-board battery, and wherein the first DC power is used to charge the battery.

18. The ECAPS of claim 8, wherein the received DC power received by the first ECU is approximately 100 percent of any power received by the ECU.

19. The ECAPS of claim 8, wherein the received DC power received by the first ECU is approximately 100 percent of any power used by the ECU to operate the first variable-speed compressor not consumed by the ECU for onboard control purposes and/or ancillary purposes.

20. The ECAPS of claim 8, wherein the first ECU includes a controller that operates on the received DC power, wherein approximately 100 percent of the remaining received DC power is used to operate the first variable-speed compressor.

21. The ECAPS of claim 8, wherein the generator unit is a self-contained unit, and wherein the first ECU is a self-contained unit.

22. A generator unit, comprising:
a variable-speed compression-ignition engine;
a first generator mechanically coupled to the engine and adapted to vary in speed so as to produce first AC power at a variable frequency;
a first rectification assembly adapted to transform the first AC power produced by the first generator and/or external AC power to produce a first DC power; and
a first DC output power outlet adapted to output the first DC power produced by the first rectification assembly as first output DC power, wherein the first DC power is approximately 100 percent of any power produced by the first generator not consumed by the generator unit for on-board purposes.

23. The generator unit of claim 22, wherein the generator unit includes an on-board battery, and wherein the first DC power is used to charge the battery.

24. The generator unit of claim 22, further comprising:
a battery; and
a second generator mechanically coupled to the engine,
wherein the second generator produces at least one of a second AC power and a second DC power, at least a portion of the second AC power and/or the second DC power being ultimately used to recharge the battery.

25. The generator unit of claim 22, further comprising:
an inverter assembly adapted to invert at least a portion of the first DC power to fixed-frequency AC power; and
an AC power outlet adapted to output the fixed-frequency AC power from the generator unit,
wherein the generator is a permanent magnet alternator, and
wherein the rectifier is at least one of a passive rectifier and an active rectifier.

26. An environmental control and power system (ECAPS), comprising:
the generator unit of claim 22;
a first environmental control unit (ECU) adapted to receive DC power external from the first ECU, the first ECU including a variable-speed compressor driven by a first variable-speed DC motor powered by the received DC power external from the first ECU, the variable-speed compressor being part of a refrigeration circuit of the ECU, the ECU being adapted to cool air and export the cooled air out of the ECU, wherein the first DC motor includes a motor commutation controller which receives DC power as input power; and
a controller in communication with the first ECU and adapted to vary the speed of the variable-speed compressor depending on a need for cooled air outputted by the ECU, the controller also being in communication with the generator unit and adapted to control a speed of the engine and first generator and to control the first DC power to have a first voltage value and a first current value,
wherein the at least a portion of the first output DC power transferred from the variable-speed generator unit to the first ECU is the received DC power received by the first ECU,
wherein the first ECU includes an electrically powered Rankin-cycle refrigeration circuit in which more than 50% of the electrical power consumed by refrigeration circuit is DC power.

27. A self-contained ECU, adapted to output cooled air to a separate temporary enclosure, comprising:
a DC power inlet adapted to receive a first DC power external from the ECU;
a variable-speed compressor;
a DC variable-speed motor powered by the first DC power, the DC variable-speed motor including a stator, a controller commutator, and a rotor driving the variable speed compressor, the variable-speed compressor being part of a Rankin-cycle refrigeration circuit in the ECU powered by electricity, the electricity powering the refrigeration circuit being more than 50% DC electrical power; and
a controller adapted to vary the speed of the variable-speed compressor depending on a need for cooled air in the temporary shelter.
